(19) United States
(12) Patent Application Publication
(10) Pub. No.: US 2014/0278793 A1
(43) Pub. Date: Sep. 18, 2014

(54) MOBILE SYSTEMS AND METHODS FOR CUSTOMER FEEDBACK

(71) Applicant: Alex Beltrani, Setauket, NY (US)

(72) Inventor: Alex Beltrani, Setauket, NY (US)

(21) Appl. No.: 14/215,587

(22) Filed: Mar. 17, 2014

Related U.S. Application Data
(60) Provisional application No. 61/794,349, filed on Mar. 15, 2013.

(51) Int. Cl. G06Q 30/02

(52) U.S. Cl. CPC G06Q 30/0203
USPC 705/7.32

(57) ABSTRACT

Computer-implemented methods, systems, and computer-readable media for collecting customer feedback are disclosed. In one embodiment, a merchant provides registration data, defines one or more surveys, and one or more customer deals to a database. Each survey is linked to a customer deal. A customer of the merchant is induced to participate in a survey using his or her mobile device by the promise of receiving a deal for discounted goods or services in return for completing the survey. Upon completion of the survey, a deal certificate is issued to the customer. Survey results, deal redemption statistics, and other statistical analysis are provided to the merchant to enable the merchant to timely assess the performance of his business.

### CROSS REFERENCE TO RELATED APPLICATION

This application claims the benefit of and priority to U.S. Provisional Application Ser. No. 61/794,349 entitled “MOBILE APPLICATION FOR CUSTOMER FEEDBACK” filed Mar. 15, 2013, the entirety of which is hereby incorporated by reference herein for all purposes.

### BACKGROUND

1. Technical Field

The present disclosure is directed to a rating system suitable for use with mobile devices, and more particularly, to a system and related methods for collecting customer feedback using a mobile device, and providing such feedback in an efficient and meaningful manner to a merchant.

2. Description of Related Art

The mobile telecommunications industry has experienced phenomenal growth in recent years. It is estimated that there are now over 4 billion cellular telephone subscribers worldwide. Modern cellular telephones can accomplish much more than merely making telephone calls. Advances in technology have enabled the integration of previously-discrete functions into a single, economically viable handheld communication device. For example, in addition to being able to make and receive telephone calls, it is common for a cellular device to include the ability to send and receive instant text and multimedia messages, send and receive internet email, browse the web, record and play back audio, photographs, and video, and to run application programs of all kinds, such as games, navigation, bookreading, and reviewing of local merchants and restaurants.

According to the National Restaurant Association, a restaurant industry business association in the United States representing more than 380,000 restaurant locations, it reported that a typical dissatisfied customer will tell 8-10 people. Those 8-10 people will each tell five more people, which means up to 50 people could be influenced by just one negative customer experience.

Currently, the most commonly used customer feedback processes for local merchants and restaurants are online forums (e.g., “Yelp”) and the use of archaic processes utilizing paper-and-pen customer comment cards. Although customer comment cards may be a comfortable and reliable process, it is an outdated and time consuming endeavor. On the other hand, while online forums may be modern and quick, it has been estimated that approximately 33%-43% of online reviews are fabricated by competitors or by paid reviewers. Additionally, once a negative review is posted on an online forum, it may be simply too late and too public to remedy.

### SUMMARY

In one aspect, the present disclosure is directed to a computer-implemented method for collecting customer feedback. In an example embodiment, the disclosed method includes receiving, at a processor, data defining at least one merchant, data defining one or more merchant surveys related to the at least one merchant, and data defining one or more merchant deals related to the at least one survey. The method includes selecting, at a customer device, one of the one or more merchant deals, completing, at the customer device, the survey related to the selected one of the one or more merchant deals, and delivering, in response to the completing, the selected one of the one or more merchant deals to a customer. In embodiments, the disclosed method includes prohibiting redemption of the deal until at least a predetermined length of time has elapsed from the delivery of the deal. In embodiments, the predetermined length of time is eight hours.

In embodiments, data defining one or more merchant surveys may include, without limitation, a survey name, a survey question category, a survey question subcategory, and/or or a survey question. In embodiments, data defining one or more merchant deals may include, without limitation, a deal name, a deal structure, an active flag, a deal start time, a deal end time, a deal redeem-by date, and/or a deal condition.

In embodiments, wherein the selection of the one or more merchant deals may be performed by automated identification of visual indicia, such as, without limitation, capturing a linear barcode, capturing a two-dimensional barcode, or performing optical character recognition.

In embodiments, the disclosed method may include receiving, at the processor, data representing the completed survey and storing, in a database in operable communication with the processor, the data representing the completed survey. In embodiments, the disclosed method may include retrieving, from the database, data representing at least one completed survey, analyzing the retrieved data to determine at least one statistical property thereof, and displaying, at a merchant device, the at least one statistical property.

In another aspect, the present disclosure is directed to a customer feedback system. In an example embodiment, the disclosed customer feedback system includes a processor, a database operably coupled to the processor, and a computer-readable storage medium operably coupled to the processor. The computer-readable storage medium includes instructions which, when executed on the processor, cause the processor to perform a method comprising receiving, at the processor, data defining at least one merchant, data defining one or more merchant surveys related to the at least one merchant, and data defining one or more merchant deals related to the at least one survey. The method further includes receiving, from a customer device, results of a completed survey related to a selected one of the one or more merchant deals; and delivering, in response to receiving the results of the completed survey, the selected one of the one or more merchant deals to a customer.

In embodiments, the customer feedback system may include instructions executable on the processor for prohibiting redemption of the deal until at least a predetermined length of time has elapsed from the delivering. In embodiments, the predetermined length of time is eight hours. In embodiments, the data defining one or more merchant surveys may include, without limitation, a survey name, a survey question category, a survey question subcategory, and/or a survey question. In embodiments, the data defining one or more merchant deals may include, without limitation, a deal name, a deal structure, an active flag, a deal start time, a deal end time, a deal redeem-by date, and/or a deal condition.

In embodiments, the customer feedback system may include instructions executable on the processor for receiving, at the processor, data representing the completed survey, and storing, in a database in operable communication with the processor, the data representing the completed survey. In embodiments, the customer feedback system may include instructions executable on the processor for retrieving, from the database, data representing at least one completed survey, analyzing the retrieved data to determine at least one statistical property thereof, and transmitting, to a merchant device, the at least one statistical property.

In yet another aspect, the present disclosure is directed to non-transitory computer-readable media storing instructions, which, when executed by a processor, cause the processor to perform a method of collecting customer feedback. In an example embodiment, the method includes receiving, at the processor, data defining at least one merchant, data defining one or more merchant surveys related to the at least one merchant, and data defining one or more merchant deals related to the at least one survey. The method further includes receiving, from a customer device, results of a completed survey related to a selected one of the one or more merchant deals, and delivering, in response to receiving the results of the completed survey, the selected one of the one or more merchant deals to a customer.

In some embodiments, the non-transitory computer-readable media further stores instructions executable on the processor for prohibiting redemption of the deal until at least a predetermined length of time has elapsed from the delivering. In some embodiments, the predetermined length of time is eight hours.

In some embodiments, the non-transitory computer-readable media further stores instructions for receiving, at the processor, data representing the completed survey, and storing, in a database in operable communication with the processor, the data representing the completed survey. In some embodiments, the non-transitory computer-readable media further stores for retrieving, from the database, data representing at least one completed survey, analyzing the retrieved data to determine at least one statistical property thereof, and transmitting, to a merchant device, the at least one statistical property.

### BRIEF DESCRIPTION OF THE DRAWINGS

Various embodiments of the disclosed system and method are described herein with reference to the drawings wherein:

FIG. 1 is a schematic diagram of an embodiment of a system for collecting customer feedback using a mobile customer device in accordance with the present disclosure;

FIG. 2 is a block diagram of an embodiment of a customer device in accordance with the present disclosure;

FIG. 3 is a block diagram of an embodiment of a customer and merchant server in accordance with the present disclosure;

FIG. 4 is a view of a merchant maintenance user interface in accordance with an example embodiment of the present disclosure;

FIG. 5 is a view of a question setup user interface in accordance with an example embodiment of the present disclosure;

FIG. 6 is a view of a survey setup user interface in accordance with an example embodiment of the present disclosure;

FIG. 7 is a view of a deals setup user interface in accordance with an example embodiment of the present disclosure;

FIG. 8 is a view of a demographics analysis user interface in accordance with an example embodiment of the present disclosure;

FIG. 9 is a view of a deal analysis user interface in accordance with an example embodiment of the present disclosure;

FIG. 10 is a view of a performance overview analysis user interface in accordance with an example embodiment of the present disclosure;

FIG. 11 is a view of a home page user interface of a customer device in accordance with an example embodiment of the present disclosure;

FIG. 12 is a view of a customer registration user interface of a customer device in accordance with an example embodiment of the present disclosure;

FIG. 13 is a view of a “My Places” user interface of a customer device in accordance with an example embodiment of the present disclosure;

FIG. 14 is a view of a “Nearby Places” user interface of a customer device in accordance with an example embodiment of the present disclosure;

FIG. 15 is a view of a “My Deals” user interface of a customer device in accordance with an example embodiment of the present disclosure;

FIG. 16 is a view of a merchant profile user interface of a customer device in accordance with an example embodiment of the present disclosure;

FIGS. 17A and 17B are views of a survey user interface of a customer device in accordance with an example embodiment of the present disclosure;

FIG. 18 is a view of a barcode scanning user interface of a customer device in accordance with an example embodiment of the present disclosure; and

FIG. 19 is a view of a social networking user interface of a customer device in accordance with an example embodiment of the present disclosure.

### DETAILED DESCRIPTION

Particular illustrative embodiments of the present disclosure are described hereinbelow with reference to the accompanying drawings; however, the disclosed embodiments are merely examples of the disclosure, which may be embodied in various forms. Well-known functions or constructions and repetitive matter are not described in detail to avoid obscuring the present disclosure in unnecessary or redundant detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

As shown in the drawings and as described throughout the following description, references to orientation, e.g., “top”, “bottom”, “upper”, “lower”, “left”, “right”, and the like, are used with reference to the figures and features shown and described herein. It is to be understood that embodiments in accordance with the present disclosure may be practiced in any orientation without limitation. In this description, as well as in the drawings, like-referenced numbers represent elements which may perform the same, similar, or equivalent functions. The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The present disclosure may be described herein in terms of functional block components, code listings, optional selections, page displays, and various processing steps. It should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices.

Similarly, the software elements of the present disclosure may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device having a data connection capable of connecting to the Internet, on a variety of operating systems including without limitation Apple OSX®, Apple iOS®, Google Android®, HP WebOS®, linux, UNIX®, Microsoft Windows®, and/or Microsoft Windows Mobile®.

It should be appreciated that the particular implementations described herein are illustrative of the disclosure and its best mode and are not intended to otherwise limit the scope of the present disclosure in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic system or apparatus. In the discussion contained herein, the terms user interface element and/or button are understood to be non-limiting, and include other user interface elements such as, without limitation, a hyperlink, clickable image, and the like.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented.

The disclosed systems and/or methods may be embodied, at least in part, in application software that may be downloaded, in whole or in part, from either a website or an application store (“app store”) to the mobile device. In another embodiment, the disclosed system and method may be included in the mobile device firmware, hardware, and/or software.

In yet other embodiments, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein.

With reference to FIG. 1, an embodiment of a customer feedback system 100 is presented. The system 100 includes a customer and merchant server 500 that is in operable communication with a data network 300. Data network 300 may encompass any suitable data network, such as, without limitation, a wireless (e.g., cellular or “WiFi”) communication network supporting any suitable data transmission protocol including without limitation CDMA, TDMA, GSM, TCP/IP, 802.11 WiFi, and the like. One or more customer devices 200 are operably coupled to the data network 300. Customer devices 200 may include any suitable mobile device adapted for mobile communication as described hereinabove. The disclosed system 100 includes at least one merchant device 400 that may include, without limitation, a workstation, personal computer, notebook computer, tablet computer, smart phone, and so forth. Merchant device 400 is in operable communication with data network 100 and includes executable software, such as a web browser, adapted to communicate with customer and merchant server 500. In embodiments, merchant device 400 is configured to manage merchant profile data (e.g., name, type of establishment, location, contact information, billing information, surveys, deals etc.) and other data stored within customer and merchant server 200. For example, a merchant may add, change, view, or delete survey question categories, survey questions, surveys, deals, links between surveys and deals, historical and statistical information, and the like.

Turning to FIG. 2, a block diagram of an embodiment of a customer device 200 in accordance with the present disclosure is presented. Customer device 200 includes a user interface unit 205 that is configured to enable interaction between customer device 200 and a user (customer), and an operational unit 230 that is in operable communication with user interface unit 205. User interface unit 205 includes at least one display unit 210 that is adapted to convey visual information to a user, and may include without limitation an LCD screen capable of displaying monochrome and/or color images, text, photographs, icons, video, and so forth as will be familiar to the skilled artisan.

User interface unit 205 includes an input unit 215 that is configured to sense inputs received from a user, such as without limitation, finger touches, finger gestures, and/or motion gestures. In an embodiment, input unit 215 may include one or more pushbuttons, a touchscreen, an accelerometer, a gyroscope, and/or combinations thereof. User interface unit 205 may includes one or more speakers 220 configured to provide audio signals to a user, and/or one or more microphones configured to capture speech and/or other audio signals. User interface unit 205 includes at least one camera 270 that facilitates the capture of photographic (still) and video (moving) images. In embodiments, camera 270 may be configured perform automated identification, e.g., to capture a barcode, such as without limitation, to capture a linear barcode (e.g., USS-128, code-39, UPC, 2 of 5, and so forth); to capture a two-dimensional barcode (e.g., QR code, PDF417, and so forth); and/or may be configured to perform optical character recognition of human-readable text.

Operational unit 230 includes a transceiver 235 adapted to facilitate data communications between customer device 200 and data network 300. Transceiver 235 may include radiofrequency modulating and demodulating units (not explicitly shown) adapted to encode and decode, respectively, data communications. In the embodiment illustrated in FIG. 2, transceiver 235 is operably coupled to an antenna 260 which, in turn, facilitates communication among and between customer device 200, data network 300, and/or customer and merchant server 500. Operational unit 230 includes a processor 240 that is operably coupled to transceiver 235, a GPS receiver 275, and a customer application (a.k.a. “app”) 255. In embodiments, GPS receiver 275 may operate in accordance with any global positioning system now or in the future known, including GPS, GLONASS, Galileo, IRNSS, BDS, and so forth.

Turning to FIG. 3, a block diagram of an embodiment of a customer and merchant server 500 in accordance with the present disclosure is presented. The customer and merchant server 500 includes at least one processor 505 that is operably coupled to a communications interface 510. Communications interface 510 is configured to be operably coupled to network 300 and may support one or more communications protocols, e.g., TCP/IP. Customer and merchant server 500 includes a memory 506 in operable communications with processor 505 that may include volatile storage (e.g., RAM) and/or non-volatile storage (e.g., solid state non-volatile memory, magnetic disk, optical disk, and the like) components.

Customer and merchant server 500 includes a merchant services module 520 that is configured to communicate with the at least one merchant device 400 to facilitate interaction between merchant device 400 and database 540 including, without limitation, the creation and verification of merchant accounts, authenticating connections and managing access permissions, enabling the merchant to manage merchant profile data, survey data, deals data, historical and statistical information, and so forth. In embodiments, merchant services module 520 includes a webserver configured to present a merchant user interface to a merchant, as described in detail below.

Customer and merchant server 500 includes a customer services module 530 that is configured to communicate with the at least one customer device 200 to facilitate interaction between customer device 200 and database 540 including, without limitation, the creation and verification of customer accounts, authenticating connections from customer application 255, receiving, storing, and managing user preferences (including authentication criteria such as password, device IMEI, etc.), enabling the customer to participate in surveys, to select participating merchants based on, for example, geographic proximity to the customer's present location, currently-offered deals by participating merchants, price range, style of establishment (e.g., Italian, Asian Fusion, Texas-Style Barbeque, etc.), deals earned, and so forth. In embodiments, customer services module 530 includes the capability to access one or more social networking accounts (e.g., Facebook™, Twitter™) associated with a customer to enable updates and messages from the customer to be shared therewith. In embodiments, customer services module 530 includes a webserver that is configured to present a customer application user interface (e.g., FIGS. 11-19) to customer application 255. In embodiments, customer application 255 may include a web browser (e.g., Safari™, Google Chrome™, etc.). In embodiments, customer application 255 may be embodied in a java applet configured to execute within a web browser running on customer device 200.

Processor 505, memory 506, merchant services module 520 and/or customer services module 530 are in operative communication with database 540. In embodiments, database 540 is a relational database having a plurality of related tables configured for storing data elements of the disclosed system and related methods for collecting customer feedback. It is envisioned that customer feedback system 100 may be used by one or more customers interacting with one or more merchants. Accordingly, a merchant table 541 is configured to store data relating to each merchant that is participating in customer feedback system 100. Each row 541a of merchant table 541 is associated with a particular merchant, and includes one or more data elements relating to the particular merchant such as, without limitation, merchant name, type of business, location, address, logo and/or other graphic elements related to branding, corporate identity, etc., email address, website URL, Facebook™ URL, Twitter™ URL, credit card, ACH, and/or other payment-related information, authentication information (user ID, password, secret questions for password recovery, etc.), desired subscription plan (e.g., monthly, quarterly, annual), desired support plan (e.g., standard 8/5 support, deluxe 24/7/365 support, email support, phone support, etc.). Merchant services module 520 is configured to provide to the merchant an “add merchant” web page to facilitate the entry and maintenance of merchant data (FIG. 4A). In embodiments, merchant sign-up is capable of being completed in a relatively fast and efficient manner, e.g., requiring roughly one to two minutes to establish a merchant account.

Database 540 includes a number of tables related to merchant table 541 to accommodate the creation and maintenance of surveys. As seen in FIG. 3, surveys table 542 is related to merchants table 541 using a one-to-many relationship, i.e., each merchant may define one or more surveys. In embodiments, depending upon which subscription plan a particular merchant has selected, the particular merchant may be limited to a finite number of surveys within a predetermined period of time and/or a finite number of concurrently-active surveys. In the illustrated embodiment, each row 542a of the surveys table represents one survey of a merchant.

In the embodiments shown herein, a survey consists of four questions which are intended to be answered easily and quickly by a customer. As an inducement to the customer to participate in a survey, each survey is associated with a customer incentive, called a deal, which is awarded to the customer upon completion of the survey. A deal may include entitling the customer to discounted (or free) goods and/or services. Thus each survey (a set of four questions) is combined with a deal (discounts) to establish a survey-deal which, in turn, is presented to the customer by the customer services module 530 in cooperation with the customer mobile application 255. While surveys described with reference to the example embodiments presented herein include four questions, it is envisioned that surveys having less than four questions, or more than four questions, may be utilized.

In embodiments, a deal may be subject to an effective redemption time range, for example, a deal may be redeemable no earlier than eight hours after the survey is completed and no later than one month after the survey is completed. In this manner, customers are precluded from applying a newly-acquired deal to the instant merchant interaction (e.g., the instant restaurant visit) giving rise to the survey, but rather, are encouraged to return to the merchant to actualize the benefits of the deal.

Surveys table 542 includes one or more rows 542a each defining a survey. As seen in the “survey setup” web pages illustrated in FIGS. 4B and 4C, each survey may include questions related to one or more particular evaluative categories of interest (e.g., décor, menu, atmosphere, service, food, value, etc. Within each category, additional subcategories may be defined. For example, and without limitation, within the “food” category subcategories “freshness”, “temperature”, and “presentation” may be defined. In embodiments, additional database tables (not explicitly shown) may be related to survey table 542 to facilitate the establishment of such survey question categories, subcategories, and so forth, as desired.

Database 540 includes a deals table 543 that is configured for storing data relating to one or more deals relating to a merchant, for example, and without limitation, a deal name, a deal structure (e.g., “10% off lunch entrees”), a deal active flag, a deal start time, a deal end time, a deal redeem-by date, and/or deal conditions or rules (e.g., “not valid for lobster tails”). In embodiments, a merchant may flag a deal as active or inactive at will, which, in turn, is reflected in substantially real-time within the customer application 255.

Survey-deal table 550 has a many-to-many structure which relates an individual survey row 542a with an individual deal row 543a to define a particular survey-deal combination. In this manner, the merchant is able to conveniently re-use surveys and/or deals without needing to redefine the elements thereof.

At least one of the survey table 542, the deals table 543, or the survey-deal table 550 may include one or more ranges of time during which the survey and/or deal is active, i.e., available to a customer. For example, a merchant may wish to promote its lunch menu. Realizing that it may not be fruitful to offer a lunch deal to existing lunchtime customers, a deal offering “50% off lunch combos” may be defined to be active only during the dinner hours, e.g., between 5:00-10:00 PM. Similarly, a restaurant offering occasional live band music on the weekends may wish to solicit feedback on the band only on those evenings during which the band is playing. Thus, either the survey or the deal may define the time slot(s) during which the survey-deal is offered. In embodiments, the merchant services module includes logic which prevents the merchant from defining survey-deal combinations with conflicting or mutually-exclusive time constraints that would prevent the survey-deal from ever becoming active. In embodiments, a merchant may define a survey and/or deal in an incremental manner, whereby a customer must complete a series of two or more surveys to earn a particular deal. In this manner, customer loyalty, customer engagement, and/or merchant revenues may be enhanced.

Database 540 includes a survey results table 544 and a deal history table 545. Survey history table includes data relating to answers collected in response to surveys, including, without limitation, the answers given by individual customer, a timestamp indicating the date and time at which the responses were collected, the associated deal, the number of surveys responded-to by a particular customer, total number of responses to a survey, and so forth. Deal history table 545 includes data relating to deal redemptions, conversion (redemption) rates, one or more timestamps indicating when a deal was issued, when a deal was redeemed, and statistics relating thereto (e.g., mean time between issuance and redemption) and other metrics.

Database 540 includes a customers table 546 that is configured to store data relating to one or more customers (users) of the disclosed system and related methods for collecting customer feedback. Customers table 546 includes data relating to customer identification and authentication, including without limitation customer name, address, gender, birthday, email, social networking page, and/or password.

Database 540 includes a number of tables related to customers table 546. As seen in FIG. 3, customers table 546 is related to a deals earned table 547, a favorites table 548, and a customer history table 549. Deals earned table 547 includes one or more rows 547a relating deals earned to a customer, including a deal identifier, a deal merchant, a timestamp, a deal name, a redemption indicator, a validity indicator, and so forth. As seen in FIG. 15 deals earned are presented to the customer in the “My Deals” panel 740 of customer application 255. In this regard, customers are able to quickly identify which deals they have earned, which, in turn, encourages the customer to return to the merchant to redeem the deal, thereby providing return business to the merchant while enabling the customer to enjoy discounted good and/or services. Favorites table 548 includes one or more rows 548a relating one or more merchants designated as a favorite to a customer. A customer is free to designate one or more merchants as a favorite, wherein, as seen in FIG. 13 a customer's favorites are presented to the customer in the “My Places” panel 720 of customer application 255. In this manner, a customer is able to quickly check the current status of his or her favorite merchants' deals to determine which merchant is offering attractive deals at any given time.

Customer history table 549 includes one or more rows 549a that are configured to store data concerning the activity of a customer, including without limitation, changes to a customer's profile, merchant visits, deals issued, deals redeemed, arrival and departure time and duration of a merchant visit (which may be based, at least in part, upon GPS data communicated from customer application 255 to customer services module 530), and the like.

Turning now to FIGS. 4-20, various example user interfaces of a system and related methods for collecting customer feedback in accordance with the present disclosure are presented. In FIG. 4, an “add merchant” web page 601 is shown which is configured to enable a merchant to interact with merchant services module 520 and/or database 540. A number of merchant data fields 602 are provided to enable a merchant to input, view, change, or delete, for example, the company name, type, location, country, state, city, zipcode, website URL, email address, a password, and/or an active radius. An image upload field 603 is provided which enables a merchant to upload an image file containing the merchant's logo in any suitable format, including without limitation JPEG, PNG, PDF, GIF, TIFF, and so forth. An uploaded logo may be inserted into one or more user interface elements presented to the merchant and/or customer(s). In embodiments, a “active radius” merchant data field merchant may be provided to enable a merchant to specify a geographic area in which a customer must be located in order to complete a survey for that merchant. Advantageously, this enables a merchant to ensure that a customer is actually visiting a merchant's establishment, or is within a merchant-defined radius, before the customer can complete a survey and qualify for a deal. This prevents the situation, for example, where a customer might try to complete a survey at home, without ever having visited the merchant's establishment, in order to get a discount for an anticipated future visit. In some embodiments, the active radius may be defined in units of 1/100 of a mile (e.g., roughly 50 feet). In use, the customer's position, which may be determined from GPS receiver 275, cellular triangulation, and/or WiFi geolocation, is compared to the merchant's active radius area. If is it determined the customer is within the merchant's active radius area, that merchant's active deal and/or surveys may be presented to the customer who, in turn, may select and complete a survey to obtain a deal. Conversely, if is it determined the customer is outside the merchant's active radius area, then that merchant's current deals and/or surveys will be unavailable to the customer, e.g., not displayed, or, alternatively, displayed in a non-selectable manner.

In FIG. 5, a “question setup” web page 610 is shown which is configured to enable a merchant to input, view, change, or delete a survey question, to assign a survey question to a particular category and a subcategory, and to enable a merchant to input, view, change, or delete a survey category or subcategory. A category list 611 is configured to display currently-defined categories, a subcategory list 612 is configured to display currently-defined subcategories, and a question list 613 is configured to display currently-defined questions. An “add categories” button 614 enables a merchant to manage (e.g., add, view, change, or delete) categories; an “add subcategories” button 615 enables a merchant to manage subcategories; and an “add questions” button 616 enables a merchant to manage questions.

Turning now to FIG. 6, a “survey setup” web page 620 is shown which includes a number of user-interface elements which enable a merchant to define survey properties, e.g., to create a survey, associate the survey with a deal, and select four questions for inclusion within a survey. A “survey name” field 621 is provided to facilitate the management of a survey name. A “deal” selector field 622 enabled the merchant to associate the survey with a desired deal. In embodiments, deal selector field 622 includes a drop down menu which presents a list of deals available to the merchant. A question header 623 indicates that the next group of properties is related to a single question (e.g., question one, two, three, or four). A category selector 624, a subcategory selector 625, and a survey question selector 626 are provided to enable a merchant to quickly drill down to the specific category, subcategory, and question desired. An “answer format” selector 627 enables a merchant to choose how he or she wishes the customer to answer, e.g., a high/low rating (e.g., 1 for best, 5 for worst), a Boolean format (e.g., true/false, yes/no), a free-form text format (for comments and suggestions), and the like.

FIG. 7 illustrates a “deals setup” page 630 that is configured to enable a merchant to view and manage one or more deals. Deals setup page 630 includes one or more deal description fields 631, each with a corresponding deal code field 632, status indicator 633, “last updated” timestamp 634, and an action selector 635. Action selector 635 is configured to enable a merchant to manage the corresponding deal (e.g., modify, select, activate, deactivate, etc.). A delete button 636, an activate button 637, and a deactivate button 638 are provided to facilitate quick access to these functions.

FIGS. 8, 9, and 10 illustrate various analytic displays which provide valuable insights to the merchant, e.g., to better understand the effectiveness of surveys and of deals, to better interpret the feedback received from customers, to more rapidly identify areas in need of attention or improvement, and so forth. For example, FIG. 8 illustrates a demographic analysis web page 640 which enables a merchant to assess the responses to a survey against the customer demographics (e.g., name, address, gender, age, etc.). FIG. 9 illustrates a deal analysis web page 650 which enable a merchant to assess which deals are most popular, whether deals result in additional purchases and spending by the customer when the deal is redeemed, redemption rates for individual deals, aggregate redemption rates, and so forth. FIG. 10 illustrates an overview web page 660 which provides a merchant with a broad performance overview of the merchant's establishment, for example, a timeline of overall survey results obtained, response rate by category of question, survey results (e.g., the establishment's performance) by category and subcategory, and so forth. In embodiments, the graphic elements of the described analytic displays are active. For example, the overview web page 660 may be configured to enable a merchant to click on a survey activity bar graph 661 which, in turn, causes results relating to that particular time slot to be displayed. In this manner, the active analytic displays enable a merchant to quickly “drill down” into the analytic data to rapidly focus on areas of interest.

Turning now to FIGS. 11-19 various aspects of the customer application 255 are illustrated. FIG. 11 illustrates an example home page 701 of customer application 255 as displayed on customer device 200. A persistent title bar 706 is displayed at the top of the page to identify the currently-displayed page, which, in this case, is the “home” page. A number of user-interface elements are provided, such as a settings button 702 that is configured to enable a customer to tailor the operation of customer application 255 in accordance with personal preferences. A “My Places” button 703 is provided that is configured to enable the customer to view and manage his or her favorite merchants, to view and manage the merchants visited, to view and manage surveys completed, and/or view and manage deals earned. A “Nearby Places” button is provide which is configured to enable a customer to view a list of merchants which are in geographic proximity to the customer's current location, which is determined at least in part from geolocation information provided by customer device 200 (e.g., from GPS receiver 275, triangulation, WiFi geolocation, and the like), in relation to location information stored in database 540 (e.g., in merchants table 541 as described hereinabove). A splash screen 705 may be presented upon the initial startup of customer application 255 and/or reactivation from the background of customer device 200 of customer application 255. When activated (either upon first use or subsequent use) customer application 255 establishes a communication link between customer application 255 and customer services module 530.

Upon a customer's first use of customer application 255, a registration screen 710 is displayed to enable a customer to establish a new customer identity (e.g., a customer account in customers table 530) within customer feedback system 100 and/or to associate customer application 255 with an existing customer account. Registration screen 710 is configured to enable a customer to enter the required identification and demographic information 711, e.g., first name, last name, email, password, state, city, gender, birthdate, etc., as described above. When the user is satisfied that the entered customer information is correct, the done button 712 is actuated, the entered data is communicated to customer services module 530, and the entered data is stored in database 540. In embodiments, a customer may be able to establish an identity using and/or linking to existing credentials, such as using Facebook™ credentials to log in.

Actuating the “My Places” button 703 of customer application 255 causes the “My Places” screen 720 (FIG. 13) to be displayed wherein a customer's favorite merchants are presented in a list. Each merchant listing 721 includes a merchant information summary 723 that includes, for example, the merchant's name, type, and distance from the customer's present location. A merchant listing may include a merchant logo 722 or other branding graphic, if one was provided by the merchant during the merchant setup process described above. A “Home” button 725 is provided to enable the customer to return to the “Home” page 701. A “drilldown” button 724 is provided on each merchant listing 721 that enables a customer to view deals associated with the listed. Actuation of “drilldown” button 724 causes the “My Deals” page 740 to be displayed (FIG. 15).

Actuating the “Nearby Places” button 704 of customer application 255 causes the “Nearby Places” screen 730 (FIG. 14) to be displayed wherein merchants in geographic proximity to the customer's location are presented in a list. Each merchant listing 731 includes a merchant information summary 733 that includes, for example, the merchant's name, type, and distance from the customer's present location. In embodiments, the merchants are listed in order of increasing distance from the customer's present location, e.g., in ascending order with the closest merchant listed at the top. A merchant listing may include a merchant logo 732 or other branding graphic, if one was provided by the merchant during the merchant setup process described above. A “drilldown” button 734 is provided on each merchant listing 721 that enables a customer to view deals associated with the listed. Actuation of “drilldown” button 734 causes the “My Deals” page 740 to be displayed (FIG. 15).

The “My Deals” page 740 displays a list of current deals offered by a merchant (FIG. 15). Merchant identification information 742, which may include name, address, and logo, are presented. A “My Deals” tab 741 and a “Profile” tab 745 are provided to enable a customer to view either a deals list 746 or a “Merchant Profile” page 750 (FIG. 16), respectively. The deals list 746 includes one or more deal listings 743 which briefly describe the terms of each deal. Each deal listing is associated with a “Tattle” button 744 which, when actuated, causes a survey screen 760 (FIGS. 17A and 17B) to be displayed which, in turn, enables the customer to take the survey and qualify to receive the associated deal.

“Merchant Profile” page 750 (FIG. 16) displays various detailed information pertaining to a merchant, including name, address, and logo 752, contact information 753 that includes, for example, a merchant telephone number, a merchant website URL, a merchant Facebook™ URL (if provided by the merchant), and a merchant Twitter™ URL (if provided). A Facebook™ sharing button 755 is provided to enable a customer to post an update to a customer Facebook™ page, and a Twitter™ sharing button 756 is provided to enable a customer to tweet to via customer's Twitter™ account. For example, and as illustrated in FIG. 19, a customer may utilize a social media page 780 to post updates to a customer's social media page and/or a merchant's social media page. A map button 754 is provided which, when actuated, presents a map indicating the location of the currently-displayed merchant. In embodiments, map button 754 may be configured to initiate a navigation function (whether included within customer application 255 or otherwise provided by customer device 200, e.g., Apple™ Maps, Google™ Maps, etc.), to provide routing from the customer's current location to the merchant's location, and/or display an estimated travel time to, or arrival time at, the merchant's location. “Merchant Profile” page 750 includes a “back” button 751 which, when actuated, returns to the previously-displayed screen.

As seen in FIGS. 17A and 17B, survey screen 760 includes a title bar which presents the name of the offer (e.g., Free Milkshake!”) to the customer. The four survey questions and corresponding answer choices are presented in a scrolling region 768. For example, the first survey question 761, e.g., “How was the temperature of your meal?” and the five answer choices 762 are presented to the customer in scrolling region 768. After entering his or her answer choice, the customer scrolls the scrolling region 768 to bring the next survey question 763 and corresponding answer choices thereto (not explicitly shown) into view, enters the desired answer choice, and so forth until the last question 764 and corresponding last set of answer choices 765 is reached. After entering the last answer choice, the customer actuates the “Done” button 766, whereupon the customer's survey answer choices are communicated to customer services module 530, and stored in database 540, and the customer receives the deal to which he or she is now entitled for completing the survey.

In another aspect illustrated in FIG. 18, customer application 255 is configured to select a deal by automated identification of visual indicia. For example, and without limitation, customer application 255 may be configured to scan a barcode 773, such as a QR code, that is provided by merchant marketing material 772 associated with a particular merchant. In embodiments, merchant marketing material 772 may include any type of printed (hard copy) or on-screen materials, such as without limitation, a table placard, a menu, a business card, a placemat, a leaflet, a web page, a PDF document, and so forth. During use, a customer is presented with a live camera display. The customer points the camera at barcode 773 so that the barcode is generally centered within a set of framing marks 771 to enable customer application 255 to decode barcode 773. Upon decoding barcode 773, customer application 255 displays the “My Deals” page 740 corresponding to the particular merchant, whereupon the customer may choose a deal, complete a survey, and receive the chosen deal. In some embodiments, optical character recognition (OCR) may be employed in addition to, or alternatively to, barcode recognition, to enable ordinary (e.g., human-readable, alphanumeric) text to be utilized to access a deal. In some embodiments, a customer may scan and decode barcode 773 using a general-purpose barcode scanning application. In these embodiments, scanning barcode 773 may direct the customer's device to a suitable application store (e.g., Apple™ App Store, Google Play™) to enable the customer to quickly and conveniently download and install customer application 255 onto customer device 200.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

What is claimed is:

1. A computer-implemented method for collecting customer feedback, comprising:
receiving, at a processor, data defining at least one merchant;
receiving, at the processor, data defining one or more merchant surveys related to the at least one merchant;
receiving, at the processor, data defining one or more merchant deals related to the at least one survey;
selecting, at a customer device, one of the one or more merchant deals;
completing, at the customer device, the survey related to the selected one of the one or more merchant deals; and
delivering, in response to the completing, the selected one of the one or more merchant deals to a customer.

2. The computer-implemented method in accordance with claim 1, further comprising:
prohibiting redemption of the deal until at least a predetermined length of time has elapsed from the delivering.

3. The computer-implemented method in accordance with claim 2, wherein the predetermined length of time is eight hours.

4. The computer-implemented method in accordance with claim 1, wherein data defining one or more merchant surveys includes at least one of a survey name, a survey question category, a survey question subcategory, or a survey question.

5. The computer-implemented method in accordance with claim 1, wherein data defining one or more merchant deals includes at least one of a deal name, a deal structure, an active flag, a deal start time, a deal end time, a deal redeem-by date, or a deal condition.

6. The computer-implemented method in accordance with claim 1, wherein selecting, at a customer device, one of the one or more merchant deals includes performing automated identification of visual indicia.

7. The computer-implemented method in accordance with claim 6, wherein performing automated identification of visual indicia includes capturing a linear barcode, capturing a two-dimensional barcode, or performing optical character recognition.

8. The computer-implemented method in accordance with claim 1, further comprising:
receiving, at the processor, data representing the completed survey; and
storing, in a database in operable communication with the processor, the data representing the completed survey.

9. The computer-implemented method in accordance with claim 8, further comprising:
retrieving, from the database, data representing at least one completed survey;
analyzing the retrieved data to determine at least one statistical property thereof; and
displaying, at a merchant device, the at least one statistical property.

10. A customer feedback system, comprising:
a processor,
a database operably coupled to the processor; and
a computer-readable storage medium operably coupled to the processor including instructions which, when executed on the processor, cause the processor to perform a method comprising:
receiving, at the processor, data defining at least one merchant;
receiving, at the processor, data defining one or more merchant surveys related to the at least one merchant;
receiving, at the processor, data defining one or more merchant deals related to the at least one survey;
receiving, from a customer device, results of a completed survey related to a selected one of the one or more merchant deals; and
delivering, in response to receiving the results of the completed survey, the selected one of the one or more merchant deals to a customer.

11. The customer feedback system in accordance with claim 10, wherein the computer-readable storage medium further includes instructions executable on the processor for prohibiting redemption of the deal until at least a predetermined length of time has elapsed from the delivering.

12. The customer feedback system in accordance with claim 11, wherein the predetermined length of time is eight hours.

13. The customer feedback system in accordance with claim 10, wherein data defining one or more merchant surveys includes at least one of a survey name, a survey question category, a survey question subcategory, or a survey question.

14. The customer feedback system in accordance with claim 10, wherein data defining one or more merchant deals includes at least one of a deal name, a deal structure, an active flag, a deal start time, a deal end time, a deal redeem-by date, or a deal condition.

15. The customer feedback system in accordance with claim 10, wherein the computer-readable storage medium further includes instructions executable on the processor for:
receiving, at the processor, data representing the completed survey; and
storing, in a database in operable communication with the processor, the data representing the completed survey.

16. The customer feedback system in accordance with claim 15, wherein the computer-readable storage medium further includes instructions executable on the processor for:
retrieving, from the database, data representing at least one completed survey;
analyzing the retrieved data to determine at least one statistical property thereof; and
transmitting, to a merchant device, the at least one statistical property.

17. Non-transitory computer-readable media storing instructions, which, when executed by a processor, cause the processor to perform a method of collecting customer feedback, the method comprising:
receiving, at the processor, data defining at least one merchant;
receiving, at the processor, data defining one or more merchant surveys related to the at least one merchant;
receiving, at the processor, data defining one or more merchant deals related to the at least one survey;
receiving, from a customer device, results of a completed survey related to a selected one of the one or more merchant deals; and
delivering, in response to receiving the results of the completed survey, the selected one of the one or more merchant deals to a customer.

18. The non-transitory computer-readable media in accordance with claim 17, wherein the computer-readable media further stores instructions executable on the processor for prohibiting redemption of the deal until at least a predetermined length of time has elapsed from the delivering.

19. The non-transitory computer-readable media in accordance with claim 17, wherein the computer-readable media further stores instructions executable on the processor for:
receiving, at the processor, data representing the completed survey; and
storing, in a database in operable communication with the processor, the data representing the completed survey.

20. The non-transitory computer-readable media in accordance with claim 19, wherein the computer-readable media further stores instructions executable on the processor for:
retrieving, from the database, data representing at least one completed survey;
analyzing the retrieved data to determine at least one statistical property thereof; and
transmitting, to a merchant device, the at least one statistical property.
